(19) United States
(12) Patent Application Publication
(10) Pub. No.: US 2026/0331356 A1
(43) Pub. Date: Oct. 22, 2026

(54) COIL COMPONENT

(71) Applicant: TDK Corporation, Tokyo (JP)

(72) Inventors: Shinnosuke SUZUKI, Tokyo (JP); Kazuya TOBITA, Tokyo (JP); Munehiro TAKAKU, Tokyo (JP); Tomohiro KAITO, Tokyo (JP)

(73) Assignee: TDK Corporation, Tokyo (JP)

(21) Appl. No.: 19/648,724

(22) Filed: Apr. 15, 2026

(30) Foreign Application Priority Data
Apr. 22, 2025 (JP) 2025-070317

(51) Int. Cl. H01F 27/28; H01F 27/29; H01F 27/32

(52) U.S. Cl. CPC H01F 27/2804; H01F 27/292; H01F 27/323; H01F 27/2809

(57) ABSTRACT

A coil component includes an element body including a plurality of insulator layers that are laminated, a coil disposed in the element body, and a terminal electrode connected to the coil and embedded in the element body. The element body includes a main surface constituting a mounting surface and orthogonal to a first direction, and an end surface adjacent to the main surface and orthogonal to a second direction. The main surface and the end surface extend along a lamination direction of the plurality of insulator layers. The terminal electrode includes an exposed surface exposed from the main surface, and a protrusion protruding to an outside of the exposed surface when viewed from the first direction. The protrusion includes a first connecting surface connecting a tip portion of the protrusion and the exposed surface. The first connecting surface is curved in a concave shape.

### TECHNICAL FIELD

The present disclosure relates to a coil component. This application claims priority based on Japanese Patent Application No. 2025-070317 filed on Apr.22, 2025, the entire contents of which are incorporated herein by reference.

### BACKGROUND

Japanese Unexamined Patent Publication No. 2014-232815 discloses a coil component including an insulator, a coil-shaped internal conductor provided in the insulator, and a terminal electrode electrically connected to the internal conductor.

### SUMMARY

A coil component according to one aspect of the present disclosure includes an element body including a plurality of insulator layers that are laminated, a coil disposed in the element body, and a terminal electrode connected to the coil and embedded in the element body, wherein the element body includes a main surface constituting a mounting surface and orthogonal to a first direction, and an end surface adjacent to the main surface and orthogonal to a second direction, the main surface and the end surface extend along a lamination direction of the plurality of insulator layers, the terminal electrode includes an exposed surface exposed from the main surface, and a protrusion protruding to an outside of the exposed surface when viewed from the first direction, the protrusion includes a first connecting surface connecting a tip portion of the protrusion and the exposed surface, and the first connecting surface is curved in a concave shape.

### BRIEF DESCRIPTION OF THE DRAWINGS

FIG. 1 is a perspective view of a coil component according to a first embodiment.

FIG. 2 is an exploded perspective view of the coil component shown in FIG. 1.

FIG. 3 is a cross-sectional view of the coil component shown in FIG. 1.

FIG. 4 is a plan view of the coil component shown in FIG. 1 viewed from a mounting surface side.

FIG. 5 is an enlarged cross-sectional view illustrating a part of FIG. 3.

FIG. 6 is an enlarged cross-sectional view illustrating a part of a coil component according to a first modification example.

FIG. 7 is an enlarged cross-sectional illustrating a part of a coil component according to a second modification example.

FIG. 8 is a perspective view of a coil component according to a second embodiment.

FIG. 9 is an exploded perspective view of the coil component shown in FIG. 8.

FIG. 10 is a cross-sectional view of the coil component shown in FIG. 8.

### DETAILED DESCRIPTION

Hereinafter, embodiments will be described in detail with reference to the accompanying drawings. In the description of the drawings, the same or equivalent elements are denoted by the same reference numerals, and redundant description will be omitted.

One aspect of the present disclosure provides a coil component capable of suppressing peeling of a terminal electrode from an element body.

A coil component according to one aspect of the present disclosure includes an element body including a plurality of insulator layers that are laminated, a coil disposed in the element body, and a terminal electrode connected to the coil and embedded in the element body, wherein the element body includes a main surface constituting a mounting surface and orthogonal to a first direction, and an end surface adjacent to the main surface and orthogonal to a second direction, the main surface and the end surface extend along a lamination direction of the plurality of insulator layers, the terminal electrode includes an exposed surface exposed from the main surface, and a protrusion protruding to an outside of the exposed surface when viewed from the first direction, the protrusion includes a first connecting surface connecting a tip portion of the protrusion and the exposed surface, and the first connecting surface is curved in a concave shape.

In the coil component described above, the terminal electrode has the protrusion protruding to the outside of the exposed surface when viewed from the first direction orthogonal to the exposed surface. When a tensile stress in the first direction is applied to the terminal electrode, the protrusion is caught by the element body and functions as an anchor. Therefore, peeling of the terminal electrode from the element body can be suppressed. The first connecting surface connecting the tip portion of the protrusion and the exposed surface is curved in a concave shape. Thereby, stress can be relieved.

### First Embodiment

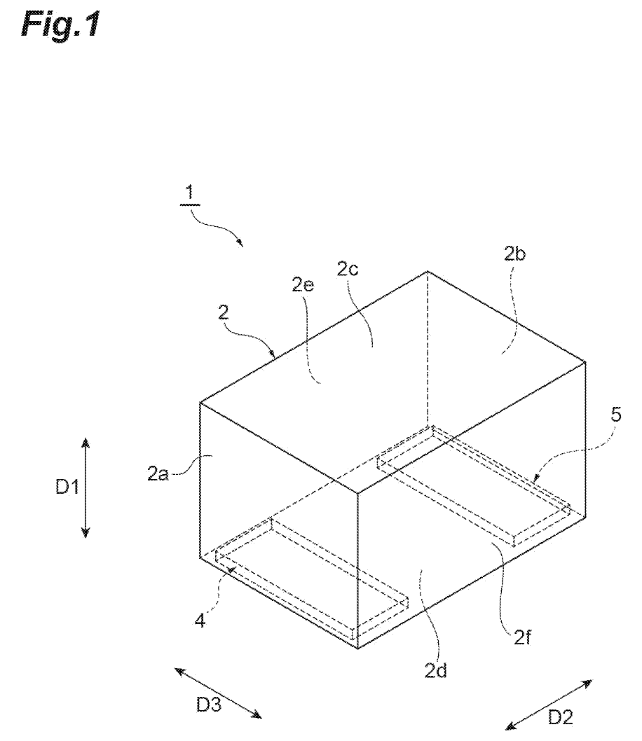

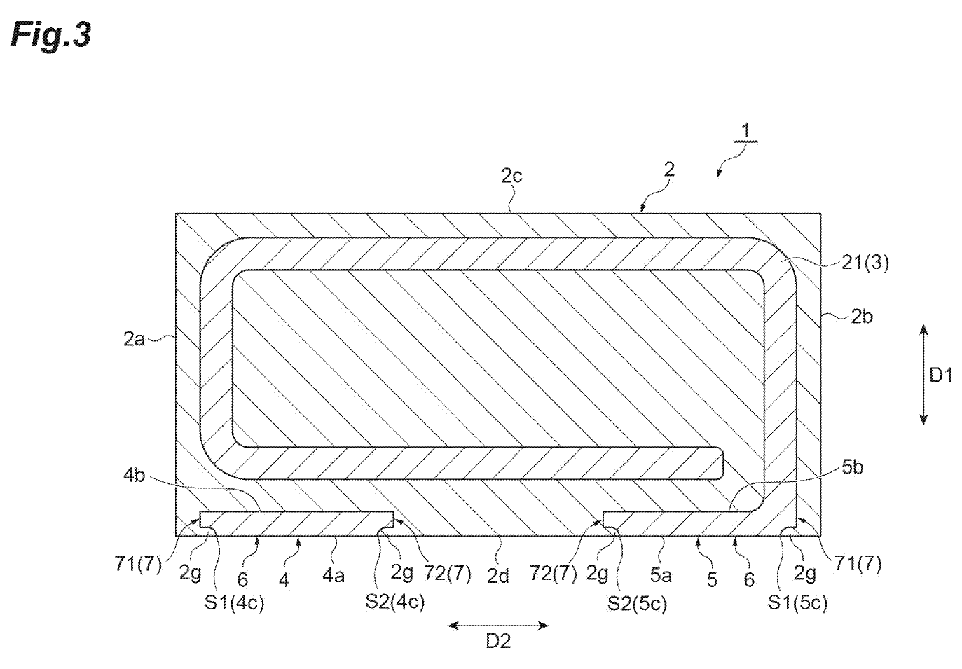

A coil component 1 according to a first embodiment will be described with reference to FIGS. 1-4. As shown in FIGS. 1-4, the coil component 1 includes an element body 2, a coil 3, a terminal electrode 4, and a terminal electrode 5. The coil component 1 is, for example, an RF (radio frequency) inductor. In FIG. 1, the terminal electrodes 4 and 5 are indicated by broken lines.

The element body 2 has a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces, a pair of end surfaces 2a and 2b, a pair of main surfaces 2c and 2d, and a pair of side surfaces 2e and 2f. The end surfaces 2a and 2b, the main surfaces 2c and 2d, and the side surfaces 2e and 2f all have a rectangular shape. Each of the main surfaces 2c and 2d is adjacent to the end surfaces 2a and 2b and the side surfaces 2e and 2f. Each of the end surfaces 2a and 2b is adjacent to the main surfaces 2c and 2d and the side surfaces 2e and 2f. Each of the side surfaces 2e and 2f is adjacent to the main surfaces 2c and 2d and the end surfaces 2a and 2b.

The main surfaces 2c and 2d oppose each other in a first direction D1. The end surfaces 2a and 2b oppose each other in a second direction D2. The side surfaces 2e and 2f oppose each other in a third direction D3. The first direction D1, the second direction D2, and the third direction D3 intersect (here, are orthogonal to) each other. In the present embodiment, the first direction D1 is a height direction of the element body 2. The second direction D2 is a length direction of the element body 2. The third direction D3 is a width direction of the element body 2.

A length of the element body 2 (length of the element body 2 in the second direction D2) is longer than a height of the element body 2 (length of the element body 2 in the first direction D1) and longer than a width of the element body 2 (length of the element body 2 in the third direction D3). The height of the element body 2 may be equivalent to the width of the element body 2, may be shorter than the width of the element body 2, or may be longer than the width of the element body 2. In the present specification, "equivalent" includes not only being equal but also a slight difference or a manufacturing error in a preset range. For example, if a plurality of values are included within a range of ±5% of an average value of the plurality of values, these values may be deemed to be equivalent. As an example, the height of the element body 2 is 200 μm. The length of the element body 2 is 400 μm. The width of the element body 2 is 200 μm. As another example, the height of the element body 2 is 200 μm. The length of the element body 2 is 300 μm. The width of the element body 2 is 150 μm.

The main surface 2d constitutes a mounting surface. The main surface 2d is a surface facing a mounting board when, for example, mounting the coil component 1 on the mounting board constituted by another electronic device (for example, a circuit board or a coil component) not shown. The end surfaces 2a and 2b and the side surfaces 2e and 2f are surfaces continuous from the main surface 2d which is the mounting surface. In the present embodiment, a long side direction of the main surfaces 2c and 2d coincides with the second direction D2. A short side direction of the main surfaces 2c and 2d coincides with the third direction D3.

The end surfaces 2a and 2b extend in the first direction D1 so as to connect between the main surfaces 2c and 2d. The end surfaces 2a and 2b also extend in the third direction D3 so as to connect between the side surfaces 2e and 2f. The main surfaces 2c and 2d extend in the second direction D2 so as to connect between the end surfaces 2a and 2b. The main surfaces 2c and 2d also extend in the third direction D3 so as to connect between the side surfaces 2e and 2f. The side surfaces 2e and 2f extend in the second direction D2 so as to connect between the end surfaces 2a and 2b. The side surfaces 2e and 2f also extend in the first direction D1 so as to connect between the main surfaces 2c and 2d.

The element body 2 is formed by laminating a plurality of insulator layers 10 in the third direction D3. That is, the lamination direction of the element body 2 is the third direction D3. In the actual element body 2, the plurality of insulator layers 10 may be integrated to such an extent that boundaries between the layers cannot be visually recognized, or may be integrated such that the boundaries between the layers can be visually recognized.

The insulator layer 10 is a resin layer made of resin. The insulator layer 10 is, for example, a non-magnetic layer containing no magnetic material. The insulator layer 10 contains, for example, at least one selected from liquid crystal polymer, polyimide resin, crystalline polystyrene, epoxy resin, acrylic resin, bismaleimide resin, and fluorine-based resin. The insulator layer 10 may contain a filler made of a non-magnetic material. Examples of the non-magnetic material include inorganic materials such as silica (SiO₂₎ and alumina (Al₂O₃). The non-magnetic material may contain a glass ceramic material or a dielectric material.

As shown in FIGS. 1-3, the terminal electrodes 4 and 5 are connected to the coil 3. The terminal electrodes 4 and 5 are embedded in the element body 2. The terminal electrodes 4 and 5 are embedded in the element body 2 while being spaced apart from each other in the second direction D2. Specifically, the terminal electrode 4 is disposed on the end surface 2a side of the element body 2. The terminal electrode 5 is disposed on the end surface 2b side of the element body 2. The terminal electrodes 4 and 5 are spaced apart from the main surface 2c, the end surfaces 2a and 2b, and the side surfaces 2e and 2f. The terminal electrodes 4 and 5 are exposed only from the main surface 2d.

The terminal electrodes 4 and 5 have exposed surfaces 4a and 5a exposed from the main surface 2d of the element body 2. The exposed surfaces 4a and 5a have, for example, a rectangular shape when viewed from the first direction D1. The exposed surfaces 4a and 5a are disposed such that each side extends along the second direction D2 or the third direction D3. A long side direction of the exposed surfaces 4a and 5a coincides with the third direction D3. A short side direction of the exposed surfaces 4a and 5a coincides with the second direction D2. The terminal electrodes 4 and 5 do not protrude beyond the main surface 2d. That is, the exposed surfaces 4a and 5a are flush with the main surface 2d.

The terminal electrodes 4 and 5 have opposing surfaces 4b and 5b opposing the exposed surfaces 4a and 5a in the first direction D1. The opposing surfaces 4b and 5b are configured by planes parallel to the exposed surfaces 4a and 5a. The opposing surfaces 4b and 5b have, for example, a rectangular shape when viewed from the first direction D1. The opposing surfaces 4b and 5b are disposed such that each side extends along the second direction D2 or the third direction D3. A long side direction of the opposing surfaces 4b and 5b coincides with the third direction D3. A short side direction of the opposing surfaces 4b and 5b coincides with the second direction D2. A length of the opposing surfaces 4b and 5b in the second direction D2 is longer than a length of the exposed surfaces 4a and 5a in the second direction D2. A length of the opposing surfaces 4b and 5b in the third direction D3 is equivalent to a length of the exposed surfaces 4a and 5a in the third direction D3.

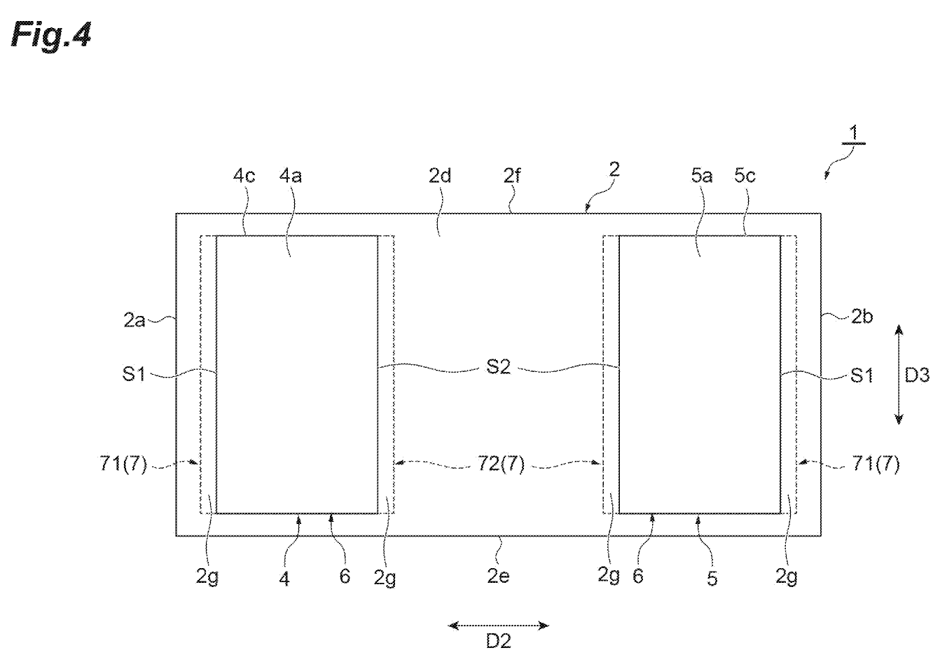

As shown in FIG. 4, each of the terminal electrodes 4 and 5 has a main body portion 6 and a protrusion 7. The main body portion 6 is a portion overlapping with the exposed surfaces 4a and 5a when viewed from the first direction D1. The protrusion 7 is a portion protruding to the outside of the exposed surfaces 4a and 5a when viewed from the first direction D1. It can also be said that the protrusion 7 protrudes from the main body portion 6 in a direction along the exposed surfaces 4a and 5a. Each of rectangular outer edges 4c and 5c of the exposed surfaces 4a and 5a has a pair of sides S1 and S2 extending along the lamination direction (third direction D3) of the plurality of insulator layers 10. The sides S1 and S2 are spaced apart from each other in the second direction D2.

The side S1 is located closer to an end portion of the element body 2 in the second direction D2, and the side S2 is located closer to a central portion of the element body 2 in the second direction D2. In the terminal electrode 4, the side S1 is located closer to the end surface 2a than the side S2 is. In the terminal electrode 5, the side S1 is located closer to the end surface 2b than the side S2 is.

The protrusion 7 has protrusions 71 and 72. The protrusion 71 protrudes from the side S1 to the outside of the exposed surfaces 4a and 5a when viewed from the first direction D1. The protrusion 72 protrudes from the side S2 to the outside of the exposed surfaces 4a and 5a when viewed from the first direction D1. The protrusion 71 extends over the entire length of the side S1. The protrusion 72 extends over the entire length of the side S2.

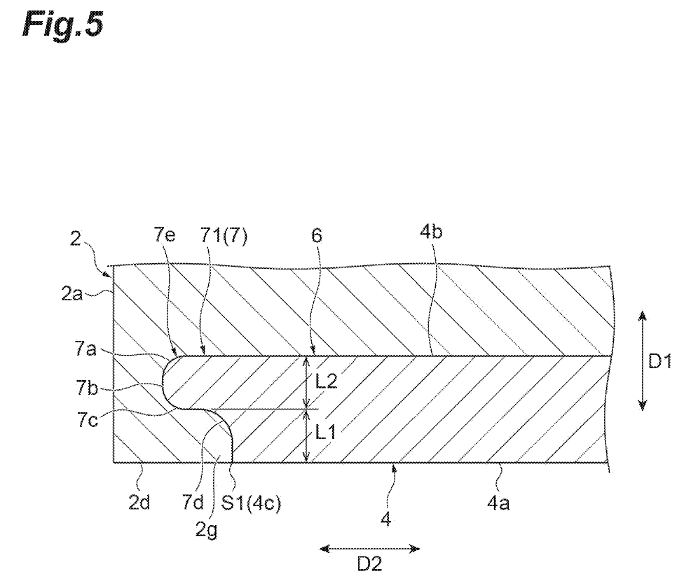

In FIG. 5, the protrusion 71 of the terminal electrode 4 will be further described as one of the protrusions 7. The protrusion 71 includes, as its surface, a part of the opposing surface 4b, a connecting surface 7a (second connecting surface), a tip surface 7b (tip), a connecting surface 7c, and a connecting surface 7d (first connecting surface). The connecting surface 7a connects the part of the opposing surface 4b and the tip surface 7b. The connecting surface 7a is a curved surface that connects the part of the opposing surface 4b and the tip surface 7b and is curved in a convex shape. In the present embodiment, the tip surface 7b is a flat surface (tip surface) extending along the first direction D1 and the third direction D3. The connecting surface 7c is a curved surface that connects the tip surface 7b and the connecting surface 7d and is curved in a convex shape. The connecting surface 7d is a curved surface that connects a tip portion 7e of the protrusion 7 and the exposed surface 4a and is curved in a concave shape. It can also be said that the connecting surface 7d connects the tip portion 7e of the protrusion 7 and the main body portion 6. The entire connecting surface 7d may be curved, or a part of the connecting surface 7d may be curved.

The tip portion 7e is a portion including the connecting surface 7a, the tip surface 7b, and the connecting surface 7c as its surface. It can also be said that the connecting surface 7d connects the connecting surface 7c and the exposed surface 4a. A radius of curvature of the connecting surface 7d is longer than a radius of curvature of the connecting surface 7a. As an example, the radius of curvature of the connecting surface 7d is longer than 3 μm, and the radius of curvature of the connecting surface 7a is 3 μm or less. The radius of curvature of the connecting surface 7d is longer than a radius of curvature of the connecting surface 7c. The radius of curvature of the connecting surface 7c is, for example, equivalent to the radius of curvature of the connecting surface 7a.

The element body 2 has a covering portion 2g covering the protrusion 7. The covering portion 2g overlaps with the protrusion 7 in its entirety when viewed from the first direction D1. The covering portion 2g has, as its surface, a portion of the main surface 2d overlapping with the protrusion 7 in its entirety when viewed from the first direction D1. The covering portion 2g has, as its surface, a curved surface that is disposed in contact with the connecting surface 7d and is curved in a convex shape.

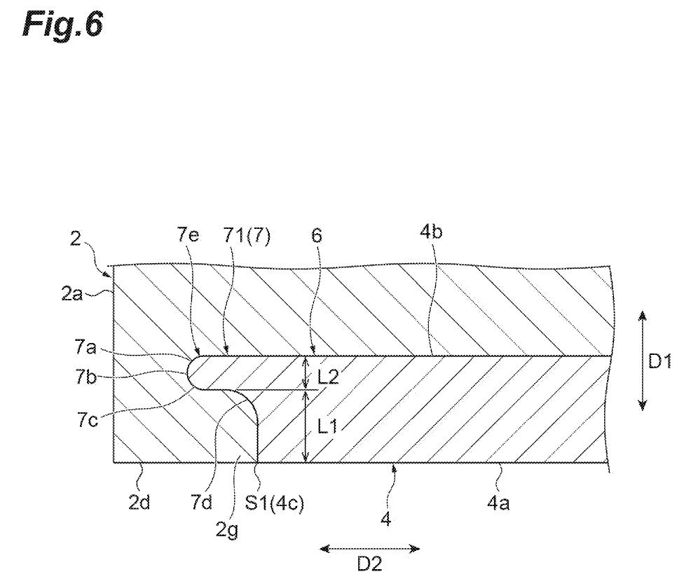

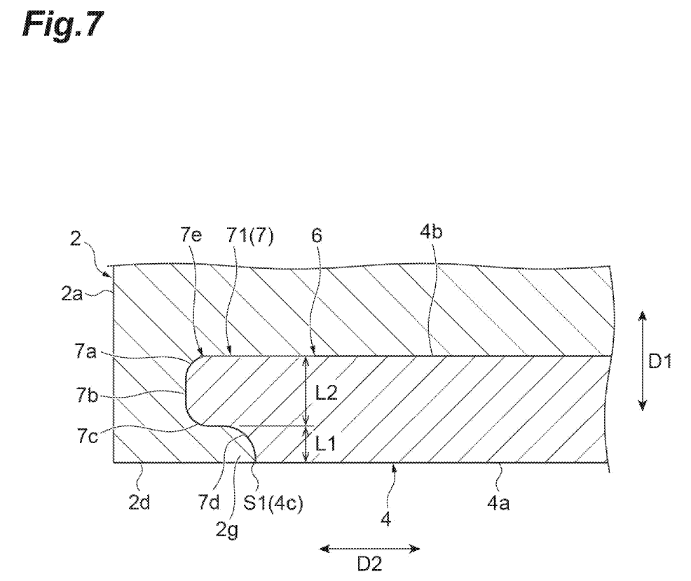

In the example of FIG. 5, a length L1 of the connecting surface 7d in the first direction D1 is equivalent to a length L2 of the tip portion 7e in the first direction D1. The length L1 may be longer than the length L2 as shown in FIG. 6. The length L1 may be shorter than the length L2 as shown in FIG. 7. A ratio L1/L2 of the length L1 to the length L2 is, for example, 1/3 or more and 3 or less. Since the length L1 can be made equal to or longer than a predetermined length by setting the ratio L1/L2 to 1/3 or more, the radius of curvature of the curve of the connecting surface 7d can be increased. Since the thickness of the protrusion 7 is secured by setting the ratio L1/L2 to 3 or less, durability of the protrusion 7 can be enhanced. The length L1 may be 5 μm or more and 15 μm or less.

A length by which the protrusion 7 protrudes from the exposed surfaces 4a and 5a (length of the protrusion 7 in the second direction D2) when viewed from a direction orthogonal to the exposed surfaces 4a and 5a (the first direction D1 in the present embodiment) is, for example, equal to or less than a thickness of the terminal electrodes 4 and 5 (length of the terminal electrodes 4 and 5 in the first direction D1), and may be 10 μm or less. Thereby, the terminal electrodes 4 and 5 (protrusion 7) are disposed in the element body 2 without being exposed from the end surfaces 2a and 2b. The length by which the protrusion 7 protrudes from the exposed surfaces 4a and 5a may be, for example, 3 μm or more. Thereby, since the length of the terminal electrodes 4 and 5 (protrusion 7) can be secured, the radius of curvature of the curve of the connecting surface 7d can be increased.

Although illustration is omitted, the protrusion 72 of the terminal electrode 4 also has the same structure as the protrusion 71 of the terminal electrode 4. The protrusions 71 and 72 of the terminal electrode 5 have the same structure as the protrusion 71 of the terminal electrode 4 except that they include a part of the opposing surface 5b instead of a part of the opposing surface 4b as their surface.

The terminal electrodes 4 and 5 are made of a conductive material (for example, Cu). The terminal electrodes 4 and 5 may be provided with a plating layer (not shown) containing, for example, Ni, Sn, Au, or the like by being subjected to electrolytic plating or electroless plating. The plating layer may include, for example, a Ni plating film containing Ni and covering the terminal electrodes 4 and 5, and an Au plating film containing Au and covering the Ni plating film.

The terminal electrode 4 is formed by laminating a plurality of electrode layers 11. A lamination direction of the plurality of electrode layers 11 coincides with the lamination direction of the plurality of insulator layers 10 (third direction D3). The electrode layer 11 penetrates the corresponding insulator layer 10 in the third direction D3. A thickness of the electrode layer 11 (thickness of the electrode layer 11 in the third direction D3) is equivalent to a thickness of the insulator layer 10 (thickness of the insulator layer 10 in the third direction D3).

The terminal electrode 5 is formed by laminating a plurality of electrode layers 12. A lamination direction of the plurality of electrode layers 12 coincides with the lamination direction of the plurality of insulator layers 10 (third direction D3). The electrode layer 12 penetrates the corresponding insulator layer 10 in the third direction D3. A thickness of the electrode layer 12 (thickness of the electrode layer 12 in the third direction D3) is equivalent to the thickness of the insulator layer 10 (thickness of the insulator layer 10 in the third direction D3).

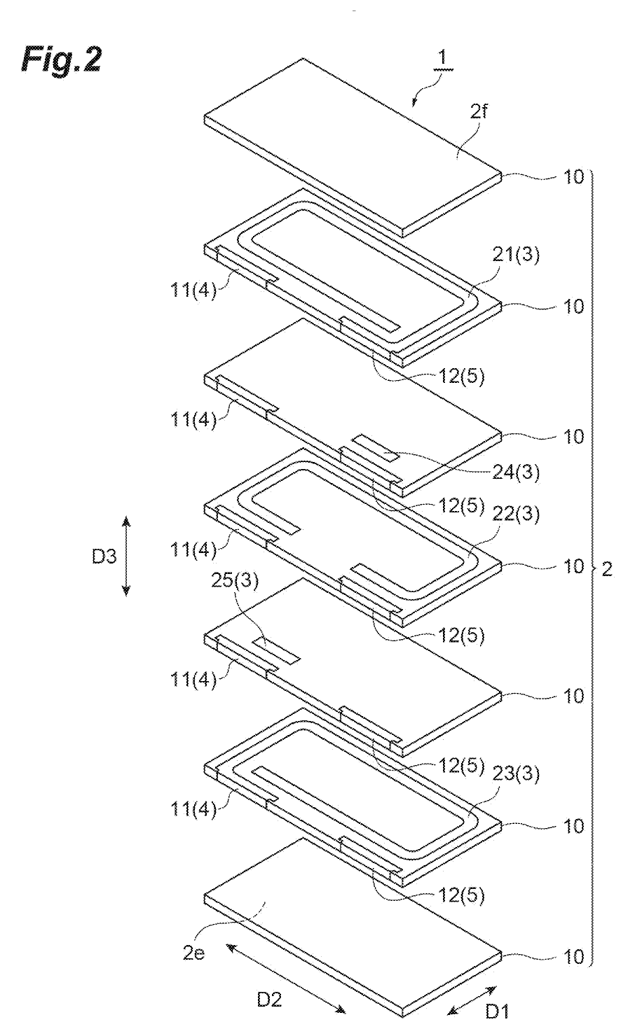

As shown in FIG. 2, the coil 3 is disposed in the element body 2 and spaced apart from the outer surface of the element body 2. The coil 3 is made of a conductive material (for example, Cu). In the present embodiment, an axial direction of the coil 3 coincides with the lamination direction of the plurality of insulator layers 10 (third direction D3), but does not have to coincide.

The coil 3 has coil conductors 21, 22, and 23, and connecting portions 24 and 25. The coil 3 is configured by electrically connecting the coil conductors 21, 22, and 23 via the connecting portions 24 and 25. The coil conductors 21, 22, and 23 and the connecting portions 24 and 25 penetrate the corresponding insulator layers 10 in the third direction D3. A thickness of the coil conductors 21, 22, and 23 and the connecting portions 24 and 25 (thickness of the coil conductors 21, 22, and 23 and the connecting portions 24 and 25 in the third direction D3) is equivalent to the thickness of the insulator layer 10 (thickness of the insulator layer 10 in the third direction D3).

The coil conductor 21 is disposed in the same insulator layer 10 as the electrode layer 12 disposed closest to the side surface 2f among the plurality of electrode layers 12, and one end of the coil conductor 21 is connected to the electrode layer 12. The other end of the coil conductor 21 is connected to one end of the coil conductor 22 by the connecting portion 24. The other end of the coil conductor 22 is connected to one end of the coil conductor 23 via the connecting portion 25. One end of the coil conductor 23 is disposed in the same insulator layer 10 as the electrode layer 11 disposed closest to the side surface 2e among the plurality of electrode layers 11, and the other end of the coil conductor 23 is connected to the electrode layer 11.

The coil 3 is connected to the protrusion 7. One end of the coil 3 is configured by the one end of the coil conductor 21 and is connected to the protrusion 71 of the terminal electrode 5. The other end of the coil 3 is configured by the other end of the coil conductor 23 and is connected to the protrusion 71 of the terminal electrode 4.

The coil component 1 can be manufactured as follows. The element body 2 is formed by laminating the insulator layers 10 by a so-called thin film method. As an example, first, the insulator layer 10 constituting the side surface 2e is formed on a support substrate. Next, after forming conductor portions to become the coil conductor 23, the electrode layer 11, and the electrode layer 12 on the insulator layer 10 constituting the side surface 2e, the insulator layer 10 is formed around the conductor portions. The conductor portions are formed by plating after forming a seed layer. Such formation of the conductor portions and the insulator layers 10 is repeated, and finally, the insulator layer 10 constituting the side surface 2f is formed.

As described above, in the coil component 1, the terminal electrodes 4 and 5 have the protrusion 7 protruding to the outside of the exposed surfaces 4a and 5a when viewed from the first direction D1 orthogonal to the exposed surfaces 4a and 5a. When a tensile stress in the first direction D1 is applied to the terminal electrodes 4 and 5, the protrusion 7 is caught by the covering portion 2g of the element body 2 and functions as an anchor. Therefore, peeling of the terminal electrodes 4 and 5 from the element body 2 can be suppressed.

The connecting surface 7d connecting the tip portion 7e of the protrusion 7 and the exposed surfaces 4a and 5a is curved in a concave shape. If the connecting surface 7d is not a curved surface but has an angular portion, stress may concentrate on that portion and a crack may occur. If a crack occurs, a part of the terminal electrodes 4 and 5 may detach from the element body 2. In the present embodiment, since the connecting surface 7d is a curved surface, stress can be relieved. Therefore, detachment of the terminal electrodes 4 and 5 can be suppressed.

Since the connecting surface 7d is a concave curved surface, a volume of the covering portion 2g of the element body 2 can be increased as compared with a configuration in which the connecting surface 7d is a flat surface or a convex curved surface. Thereby, the strength of the covering portion 2g is improved, and the anchor effect is improved.

In the terminal electrodes 4 and 5, the connecting surface 7a connecting the opposing surfaces 4b and 5b and the tip surface 7b of the protrusion 7 is curved in a convex shape. Since the radius of curvature of the connecting surface 7d is longer than the radius of curvature of the connecting surface 7a, stress can be further relaxed. Further, since a contact area between the connecting surface 7d and the covering portion 2g can be increased, the adhesion strength between the terminal electrodes 4 and 5 and the covering portion 2g is improved. As a result, detachment of the terminal electrodes 4 and 5 can be further suppressed.

The terminal electrodes 4 and 5 have protrusions 71 and 72 protruding to both sides in the second direction D2 as the protrusion 7, and have a T-shape when viewed from the third direction D3. Therefore, the anchor effect by the protrusion 7 is further improved. The protrusion 71 extends over the entire length of the side S1 of the terminal electrodes 4 and 5. The protrusion 72 extends over the entire length of the side S2 of the terminal electrodes 4 and 5. Therefore, the anchor effect by the protrusion 7 is further improved.

The coil 3 is connected to the protrusion 7. High-frequency current flows through the skin of a conductor. Therefore, the high-frequency current introduced from the exposed surfaces 4a and 5a flows to the coil 3 through the connecting surface 7d. Since the connecting surface 7d is a curved surface, the high-frequency current flows smoothly. In a case where the insulator layer 10 is made of resin and the coil component 1 is manufactured by filling resin around the conductor portions, the resin can be easily filled because the connecting surface 7d is a curved surface. Therefore, formation of voids inside the element body 2 due to poor filling of the resin can be suppressed.

### Second Embodiment

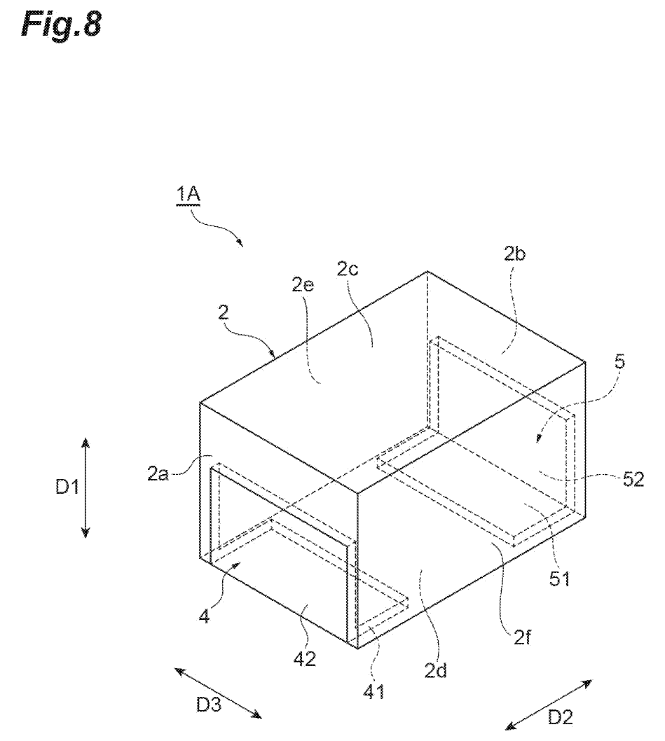

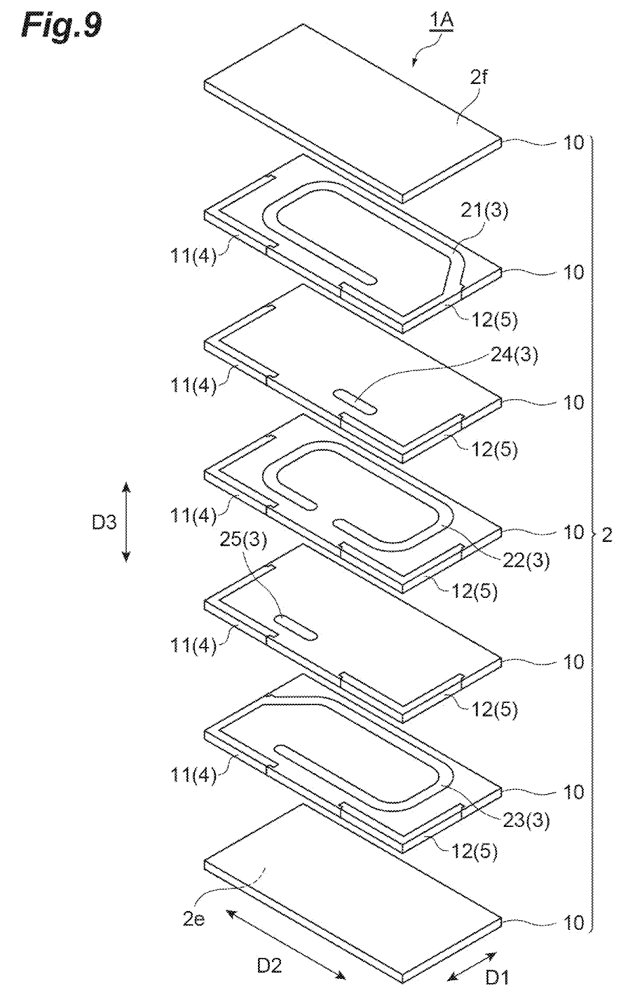

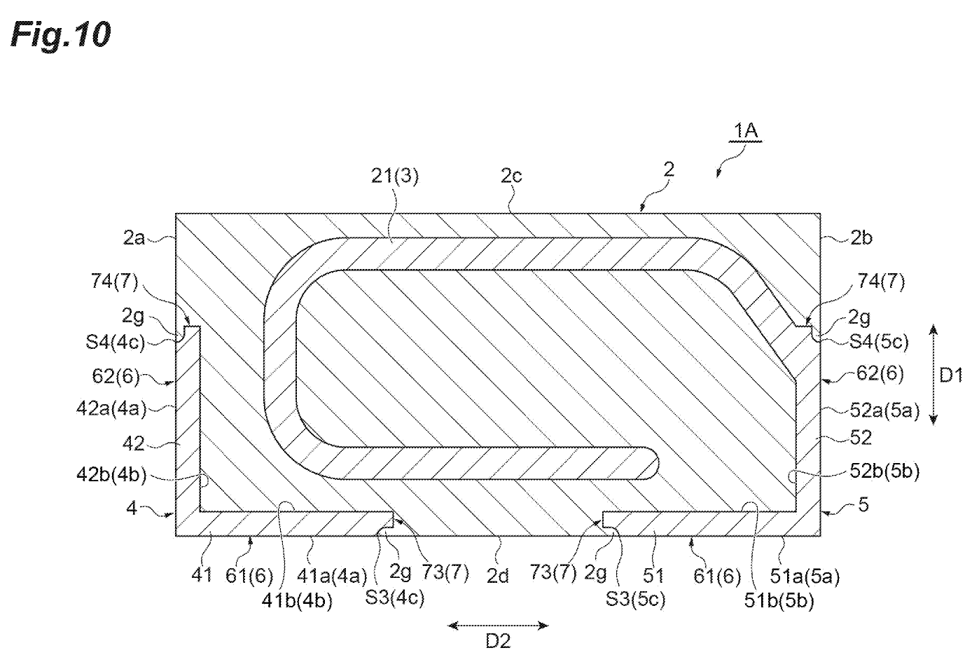

A coil component 1A according to a second embodiment will be described with reference to FIGS. 8-10. As shown in FIGS. 8-10, the coil component 1A differs from the coil component 1 mainly in shapes of the terminal electrodes 4 and 5. Hereinafter, the coil component 1A will be described focusing on differences from the coil component 1.

The terminal electrode 4 has an L-shape when viewed from the third direction D3. The terminal electrode 4 is embedded in the element body 2 so as to be exposed from the main surface 2d and the end surface 2a. The terminal electrode 4 has an exposed surface 4a exposed from the main surface 2d and the end surface 2a, and an opposing surface 4b opposing the exposed surface 4a. The terminal electrode 4 has electrode portions 41 and 42. The electrode portion 41 is embedded in the element body 2 so as to be exposed from the main surface 2d. The electrode portion 42 is embedded in the element body 2 so as to be exposed from the end surface 2a. The electrode portions 41 and 42 are connected to each other at a ridge line portion between the end surface 2a and the main surface 2d of the element body 2. The electrode portions 41 and 42 are electrically connected to each other. The terminal electrode 4 is spaced apart from the end surface 2b, the main surface 2c, and the side surfaces 2e and 2f.

The electrode portion 41 extends in the second direction D2 and the third direction D3. The electrode portion 41 has an exposed surface 41a exposed from the main surface 2d, and an opposing surface 41b opposing the exposed surface 41a in the first direction D1. The exposed surface 41a constitutes the same plane as the main surface 2d. The opposing surface 41b is configured by a flat surface parallel to the exposed surface 41a.

The electrode portion 42 extends in the first direction D1 and the third direction D3. The electrode portion 42 has an exposed surface 42a exposed from the end surface 2a, and an opposing surface 42b opposing the exposed surface 42a in the second direction D2. The exposed surface 42a constitutes the same plane as the end surface 2a. The opposing surface 42b is configured by a flat surface parallel to the exposed surface 42a.

The exposed surfaces 41a and 42a are connected to each other at the ridge line portion between the end surface 2a and the main surface 2d of the element body 2. The exposed surface 4a includes the exposed surfaces 41a and 42a. The opposing surfaces 41b and 42b are connected to each other. The opposing surface 4b includes the opposing surfaces 41b and 42b.

The terminal electrode 5 has an L-shape when viewed from the third direction D3. The terminal electrode 5 is embedded in the element body 2 so as to be exposed from the main surface 2d and the end surface 2b. The terminal electrode 5 has an exposed surface 5a exposed from the main surface 2d and the end surface 2b, and an opposing surface 5b opposing the exposed surface 5a. The terminal electrode 5 has electrode portions 51 and 52. The electrode portion 51 is embedded in the element body 2 so as to be exposed from the main surface 2d. The electrode portion 52 is embedded in the element body 2 so as to be exposed from the end surface 2b. The electrode portions 51 and 52 are connected to each other at a ridge line portion between the end surface 2b and the main surface 2d of the element body 2. The electrode portions 51 and 52 are electrically connected to each other. The terminal electrode 5 is spaced apart from the end surface 2a, the main surface 2c, and the side surfaces 2e and 2f.

The electrode portion 51 extends in the second direction D2 and the third direction D3. The electrode portion 51 has an exposed surface 51a exposed from the main surface 2d, and an opposing surface 51b opposing the exposed surface 51a in the first direction D1. The exposed surface 51a constitutes the same plane as the main surface 2d. The opposing surface 51b is configured by a flat surface parallel to the exposed surface 51a.

The electrode portion 52 extends in the first direction D1 and the third direction D3. The electrode portion 52 has an exposed surface 52a exposed from the end surface 2b, and an opposing surface 52b opposing the exposed surface 52a in the second direction D2. The exposed surface 52a constitutes the same plane as the end surface 2b. The opposing surface 52b is configured by a flat surface parallel to the exposed surface 52a.

The exposed surfaces 51a and 52a are connected to each other at the ridge line portion between the end surface 2b and the main surface 2d of the element body 2. The exposed surface 5a includes the exposed surfaces 51a and 52a. The opposing surfaces 51b and 52b are connected to each other. The opposing surface 5b includes the opposing surfaces 51b and 52b.

In the present embodiment, each of the outer edges 4c and 5c of the exposed surfaces 4a and 5a has a pair of sides S3 and S4 extending along the lamination direction (third direction D3). The sides S3 of the exposed surfaces 4a and 5a are both located on the main surface 2d. The side S4 of the exposed surface 4a is located on the end surface 2a. The side S4 of the exposed surface 5a is located on the end surface 2b.

The protrusion 7 protrudes to the outside of the exposed surfaces 4a and 5a when viewed from the first direction D1 or the second direction D2. In the present embodiment, the protrusion 7 has protrusions 73 and 74. The protrusion 73 protrudes from the side S3 to the outside of the exposed surfaces 41a and 51a when viewed from the first direction D1. The protrusion 74 protrudes from the side S4 to the outside of the exposed surfaces 42a and 52a when viewed from the second direction D2. The protrusion 73 extends over the entire length of the side S3. The protrusion 74 extends over the entire length of the side S4. The structures of the protrusions 73 and 74 are the same as that of the protrusion 7 of the coil component 1.

The main body portion 6 overlaps with the exposed surfaces 4a and 5a when viewed from the first direction D1 or the second direction D2. In the present embodiment, the main body portion 6 has main body portions 61 and 62. The main body portion 61 overlaps with the exposed surfaces 41a and 51a when viewed from the first direction D1. The main body portion 62 overlaps with the exposed surfaces 42a and 52a when viewed from the second direction D2. The main body portions 61 and 62 are connected to each other. It can also be said that the protrusion 73 protrudes from the main body portion 61 in a direction along the exposed surfaces 41a and 51a. It can also be said that the protrusion 74 protrudes from the main body portion 62 in a direction along the exposed surfaces 42a and 52a.

As described above, in the coil component 1A as well, since the terminal electrodes 4 and 5 have the protrusion 7, the same effects as those of the coil component 1 can be obtained. The protrusion 73 protrudes to the outside of the exposed surfaces 41a and 51a when viewed from the first direction D1 orthogonal to the exposed surfaces 41a and 51a. When a tensile stress in the first direction D1 is applied to the terminal electrodes 4 and 5, the protrusion 73 is caught by the covering portion 2g of the element body 2 and functions as an anchor. Therefore, peeling of the terminal electrodes 4 and 5 from the element body 2 can be suppressed. The protrusion 74 protrudes to the outside of the exposed surfaces 42a and 52a when viewed from the second direction D2 orthogonal to the exposed surfaces 42a and 52a. When a tensile stress in the second direction D2 is applied to the terminal electrodes 4 and 5, the protrusion 74 is caught by the covering portion 2g of the element body 2 and functions as an anchor. Therefore, peeling of the terminal electrodes 4 and 5 from the element body 2 can be suppressed. The connecting surfaces 7d of the protrusions 73 and 74 are curved in a concave shape. Thereby, stress can be relieved.

Although the embodiments have been described above, the present invention is not necessarily limited to the above-described embodiments, and various modifications can be made without departing from the gist thereof.

The coil components 1 and 1A include four protrusions 7, but may include at least one protrusion 7. The radius of curvature of the connecting surface 7d may be equivalent to the radius of curvature of the connecting surface 7a, or may be smaller than the radius of curvature of the connecting surface 7a. The protrusion 7 extends over the entire length of the sides S1, S2, S3, and S4, but may be provided at least in a part of the sides S1, S2, S3, and S4 in the length direction. The protrusion 7 includes a part of the opposing surfaces 4b and 5b, but does not have to include such a part.

The above-described embodiments and modification examples may be combined as appropriate. As understood from the above-described embodiments and modification examples, the present specification includes the disclosure of the following aspects.

(Clause 1) A coil component comprising: an element body including a plurality of insulator layers that are laminated; a coil disposed in the element body; and a terminal electrode connected to the coil and embedded in the element body, wherein the element body includes a main surface constituting a mounting surface and orthogonal to a first direction, and an end surface adjacent to the main surface and orthogonal to a second direction, the main surface and the end surface extend along a lamination direction of the plurality of insulator layers, the terminal electrode includes an exposed surface exposed from the main surface, and a protrusion protruding to an outside of the exposed surface when viewed from the first direction, the protrusion includes a first connecting surface connecting a tip portion of the protrusion and the exposed surface, and the first connecting surface is curved in a concave shape.

(Clause 2) The coil component according to Clause 1, wherein the terminal electrode includes an opposing surface opposing the exposed surface in the first direction, the protrusion includes a second connecting surface connecting a tip of the protrusion and the opposing surface, the second connecting surface is curved in a convex shape, and a radius of curvature of the first connecting surface is longer than a radius of curvature of the second connecting surface.

(Clause 3) The coil component according to Clause 1 or 2, wherein an outer edge of the exposed surface includes a first side and a second side extending along the lamination direction, the first side and the second side are spaced apart from each other in the second direction, and the protrusion includes a first protrusion protruding from the first side to the outside of the exposed surface when viewed from the first direction, and a second protrusion protruding from the second side to the outside of the exposed surface when viewed from the first direction.

(Clause 4) A coil component comprising: an element body including a plurality of insulator layers that are laminated; a coil disposed in the element body; and a terminal electrode connected to the coil and embedded in the element body, wherein the element body includes a main surface constituting a mounting surface and orthogonal to a first direction, and an end surface adjacent to the main surface and orthogonal to a second direction, the main surface and the end surface extend along a lamination direction of the plurality of insulator layers, the terminal electrode includes an exposed surface exposed from the main surface and the end surface, and a protrusion protruding to an outside of the exposed surface when viewed from the first direction or the second direction, the protrusion includes a first connecting surface connecting a tip portion of the protrusion and the exposed surface, and the first connecting surface is curved in a concave shape.

(Clause 5) The coil component according to Clause 4, wherein the protrusion includes a first protrusion protruding to the outside of the exposed surface when viewed from the first direction, and a second protrusion protruding to the outside of the exposed surface when viewed from the second direction.

(Clause 6) The coil component according to Clause 4 or 5, wherein the terminal electrode includes an opposing surface opposing the exposed surface in the second direction, the protrusion includes a second connecting surface connecting a tip of the protrusion and the opposing surface, the second connecting surface is curved in a convex shape, and a radius of curvature of the first connecting surface is longer than a radius of curvature of the second connecting surface.

(Clause 7) The coil component according to any one of Clauses 1 to 6, wherein an outer edge of the exposed surface includes a side extending along the lamination direction, and the protrusion extends over an entire length of the side.

(Clause 8) The coil component according to any one of Clauses 1 to 7, wherein the coil is connected to the protrusion.

What is claimed is:

1. A coil component comprising:
an element body including a plurality of insulator layers that are laminated;
a coil disposed in the element body; and
a terminal electrode connected to the coil and embedded in the element body,
wherein the element body includes a main surface constituting a mounting surface and orthogonal to a first direction, and an end surface adjacent to the main surface and orthogonal to a second direction,
the main surface and the end surface extend along a lamination direction of the plurality of insulator layers,
the terminal electrode includes an exposed surface exposed from the main surface, and a protrusion protruding to an outside of the exposed surface when viewed from the first direction,
the protrusion includes a first connecting surface connecting a tip portion of the protrusion and the exposed surface, and
the first connecting surface is curved in a concave shape.

2. The coil component according to claim 1,
wherein the terminal electrode includes an opposing surface opposing the exposed surface in the first direction,
the protrusion includes a second connecting surface connecting a tip of the protrusion and the opposing surface,
the second connecting surface is curved in a convex shape, and
a radius of curvature of the first connecting surface is longer than a radius of curvature of the second connecting surface.

3. The coil component according to claim 1,
wherein an outer edge of the exposed surface includes a first side and a second side extending along the lamination direction,
the first side and the second side are spaced apart from each other in the second direction, and
the protrusion includes a first protrusion protruding from the first side to the outside of the exposed surface when viewed from the first direction, and a second protrusion protruding from the second side to the outside of the exposed surface when viewed from the first direction.

4. A coil component comprising:
an element body including a plurality of insulator layers that are laminated;
a coil disposed in the element body; and
a terminal electrode connected to the coil and embedded in the element body,
wherein the element body includes a main surface constituting a mounting surface and orthogonal to a first direction, and an end surface adjacent to the main surface and orthogonal to a second direction,
the main surface and the end surface extend along a lamination direction of the plurality of insulator layers,
the terminal electrode includes an exposed surface exposed from the main surface and the end surface, and a protrusion protruding to an outside of the exposed surface when viewed from the first direction or the second direction,
the protrusion includes a first connecting surface connecting a tip portion of the protrusion and the exposed surface, and
the first connecting surface is curved in a concave shape.

5. The coil component according to claim 4,
wherein the protrusion includes a first protrusion protruding to the outside of the exposed surface when viewed from the first direction, and a second protrusion protruding to the outside of the exposed surface when viewed from the second direction.

6. The coil component according to claim 4,
wherein the terminal electrode includes an opposing surface opposing the exposed surface in the second direction,
the protrusion includes a second connecting surface connecting a tip of the protrusion and the opposing surface,
the second connecting surface is curved in a convex shape, and
a radius of curvature of the first connecting surface is longer than a radius of curvature of the second connecting surface.

7. The coil component according to claim 1,
wherein an outer edge of the exposed surface includes a side extending along the lamination direction, and
the protrusion extends over an entire length of the side.

8. The coil component according to claim 4,
wherein an outer edge of the exposed surface includes a side extending along the lamination direction, and
the protrusion extends over an entire length of the side.

9. The coil component according to claim 1,
wherein the coil is connected to the protrusion.

10. The coil component according to claim 4,
wherein the coil is connected to the protrusion.

11. The coil component according to claim 1,
wherein the element body includes a covering portion overlapping with the protrusion in its entirety when viewed from the first direction, and
the covering portion is in contact with the first connecting surface.

12. The coil component according to claim 1,
wherein the insulator layer contains resin.

13. The coil component according to claim 1,
wherein when a length of the first connecting surface in the first direction is L1 and a length of the tip portion in the first direction is L2, a ratio L1/L2 is 1/3 or more and 3 or less.

14. The coil component according to claim 1,
wherein a length of the first connecting surface in the first direction is 5 μm or more and 15 μm or less.

15. The coil component according to claim 1,
wherein a length by which the protrusion protrudes from the exposed surface when viewed from the first direction is 10 μm or less.

16. The coil component according to claim 1,
wherein a radius of curvature of the first connecting surface is larger than 3 μm.

17. The coil component according to claim 1,
wherein the terminal electrode includes a plurality of electrode layers laminated in the lamination direction.

18. The coil component according to claim 4,
wherein the insulator layer contains resin.

19. The coil component according to claim 4,
wherein the element body includes a covering portion overlapping with the protrusion in its entirety when viewed from the first direction or the second direction, and
the covering portion is in contact with the first connecting surface.

20. The coil component according to claim 4,
wherein the terminal electrode includes a plurality of electrode layers laminated in the lamination direction.
